(19) United States
(12) Patent Application Publication
(10) Pub. No.: US 2016/0036149 A1
(43) Pub. Date: Feb. 4, 2016

(54) Connector

(71) Applicant: YAZAKI CORPORATION, Tokyo (JP)

(72) Inventor: Keigo TSUBO, Shizuoka (JP)

(21) Appl. No.: 14/884,097

(22) Filed: Oct. 15, 2015

Related U.S. Application Data
(63) Continuation of application No. PCT/JP2014/061532, filed on Apr. 24, 2014.

(30) Foreign Application Priority Data
Apr. 26, 2013 (JP) 2013-093372

(51) Int. Cl. H01R 12/77; H01R 13/629; H01R 13/502

(52) U.S. Cl. CPC H01R 12/77; H01R 13/502; H01R 13/629

(57) ABSTRACT

Provided is a connector that can facilitate its assembly and that can be manufactured at low cost. The connector is configured to connect an FPC cable having conductors arranged in a flat plate shape to an external electrical device or another cable. A first housing is attached at opposite ends of the FPC cable. Pegs are provided at opposite ends of a second housing. Latching protrusions formed at the first housing are latched into engagement holes formed in the pegs, and guide pieces formed at the pegs are guided in guide grooves formed in the first housing, thereby preventing an increase in number of components and facilitating the assembly of the connector.

### TECHNICAL FIELD

The present invention relates to a connector to be attached to a plurality of conductors arranged in a flat plate shape.

### BACKGROUND ART

Conventionally, there is proposed a connector that includes fixture members provided to a housing and having latching protrusions to engage with a cable arranged in a flat plate shape (see Patent Literature 1). In the connector disclosed in Patent Literature 1, the fixture members are provided at opposite ends in the cable arrangement direction, and the cable is provided with concave portions that are formed at opposite ends of the cable in the cable arrangement direction and that engage with the latching protrusions. Thus, the housing engages with the cable such that a contact received in the housing is electrically connected to the conductors of the cable.

### LISTING OF PRIOR ART REFERENCES

### Patent Literatures

PATENT LITERATURE 1: Japanese Patent Application Laid-Open Publication No. 2012-119234

### SUMMARY OF THE INVENTION

### Problems to be Solved by the Invention

The connector of Patent Literature 1, however, has a problem that the cable may be inappropriately connected to the housing when the cable is engaged with the housing, causing contact failure between the conductors and the contact. Also, the connector of Patent Literature 1 is difficult to assemble. To overcome such problems, the housing may be configured to guide the cable during the insertion of the cable into the housing. However, this configuration requires that the housing be formed to conform to the dimensions of the cable, causing an increase in number of components and an increase in the cost.

An object of the present invention is to provide a connector that can be manufactured at a low cost and that can facilitate its assembly.

### Solutions to the Problems

A connector according to the present invention includes a first housing and a second housing configured to engage with the first housing, wherein one of the first housing and the second housing is attached to a plurality of conductors arranged in a flat plate shape, and another one of the first housing and the second housing is configured to receive a contact which is to be electrically connected to said plurality of conductors, wherein fixture members are provided at opposite ends of the second housing in an arrangement direction of said plurality of conductors, said fixture members being configured to secure the first housing to the second housing, and wherein said fixture member includes a latching portion for latching the first housing, and a guide portion for guiding the first housing with respect to the second housing in an engagement direction.

According to the present invention described above, one of the first housing and the second housing is attached to the conductors, and the fixture members provided to the second housing include the latching portions and the guide portions. Thus, the first housing can be easily engaged with the second housing, preventing contact failure between the conductors and the contact and facilitating the assembly. Furthermore, because the fixture members guide and latch the first housing, the configuration of the conductors can be simplified, as compared to the configuration in which the fixture members guide and latch the conductors. Also, the fixture member can be commonalized, i.e. used in common, for conductors having different dimensions, thereby reducing the cost.

Preferably, the fixture member of the connector according to the present invention is a one-piece member and includes a first face portion secured to the second housing, a second face portion that is positioned opposed to the first face portion in the arrangement direction of the conductors, and an elastically deformable connecting portion that connects the first face portion to the second face portion. Preferably, the latching portion is provided to the second face portion.

According to the configuration described above, the first face portion and the second face portion are connected to each other by the connecting portion. Thus, the fixture member may be prepared in the form of one-piece part by, for example, punching and bending a metal plate, thereby reducing the number of components and reducing the cost. Furthermore, the first face portion secured to the fixture member and the second face portion having the latching portion are opposed to each other in the conductor arrangement direction, and the first face portion and the second face portion are connected to each other by the elastically deformable connecting portion. Thus, the connecting portion can elastically deform such that the first face portion and the second face portion approach each other in the conductor arrangement direction, allowing the first housing to be easily engaged with and disengaged from the fixture member.

Preferably, for the connector according to the present invention, the first housing has a pair of engagement walls situated outward of opposite ends of said plurality of conductors in said arrangement direction, wherein the engagement wall has a latching protrusion that protrudes inward in the arrangement direction, and a guide groove that opens inward in the arrangement direction, and wherein the fixture members are arranged inward of the engagement walls and includes an engagement hole that opens outward in the arrangement direction and configured to engage with the latching protrusion, and a guide piece that protrudes outward in the arrangement direction and arranged to be inserted into the guide groove.

According to this configuration, the latching protrusions and the guide grooves are provided at inner sides of the engagement walls in the conductor arrangement direction, and the engagement holes and the guide pieces are provided at outer sides of the fixture members disposed inward of the engagement walls. Therefore, the latching protrusions and the guide pieces can be prevented from protruding outward in the conductor arrangement direction when the first housing is engaged with the second housing.

### Advantages of the Invention

According to the connector of the present invention described above, one of the first housing and the second housing is attached to the conductors, and the fixture members provided to the second housing include the latching portions and the guide portions, thereby reducing the cost and facilitating the assembly.

### BRIEF DESCRIPTION OF THE DRAWINGS

FIGS. 1A and 1B are a set of perspective views showing an entire connector according to one embodiment of the present invention.

FIG. 2 is a perspective view of a second housing of the connector.

FIG. 3 is a perspective view of a peg provided on the second housing.

FIG. 4 is a perspective view of major parts of the connector.

### DESCRIPTION OF EXEMPLARY EMBODIMENT

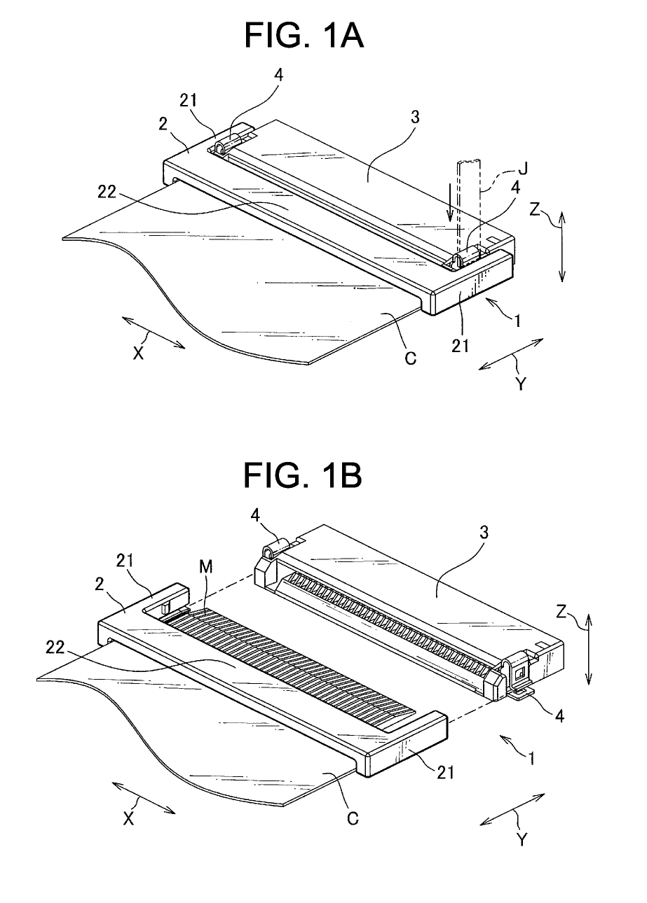

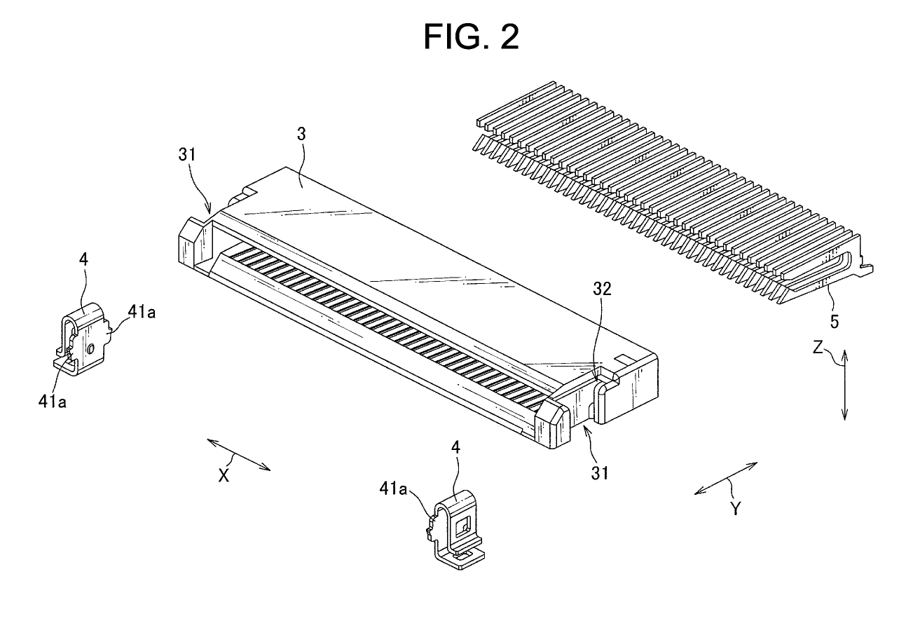

An embodiment of the present invention will now be described with reference to the drawings. As shown in FIGS. 1A, 1B and 2, a connector 1 according to this embodiment includes a first housing 2 attached on an FPC cable C having conductors M arranged in a flat plate shape, a second housing 3 to be engaged with the first housing 2, a peg 4 as a fixture member attached to the second housing 3 and configured to engage the second housing 3 with the first housing 2, and a contact 5 received in the second housing 3 and configured to be electrically connected to the conductors M of the FPC cable C. The contact 5 is electrically connected to an electrical device and/or other cables, and the FPC cable C is electrically connected to the electrical device or other cables by the connector 1. In this embodiment, as shown in FIGS. 1A and 1B, the arrangement direction of the conductors M of the FPC cable C is referred to as an X-direction, the engagement direction of the connector 1 is referred to as a Y-direction, and a direction perpendicular to a face of the FPC cable is referred to as a Z-direction. The upward and downward in the Z-direction should be referenced to FIGS. 1A and 1B.

The first housing 2 has a pair of engagement walls 21 situated outward of the opposite ends of the FPC cable C in the X-direction, and a main body 22 situated above the FPC cable C in the Z-direction and connecting the engagement walls 21 to each other. The first housing 2 is attached to the FPC cable C by the engagement walls 21 and the main body 22. As shown in FIG. 4, a latching protrusion 23 and a guide groove 24 are provided to an inner side (i.e. to a side of the FPC cable C) of the engagement wall 21 in the X-direction. It should be noted here that the first housing 2 is made from, for example, insulating resin.

The contact 5 is inserted into the second housing 3 from the side opposite of the FPC cable C in the Y-direction, and the pegs 4 are attached to the opposite ends of the second housing 3 in the X-direction. It should be noted here that the second housing 3 is made from, for example, insulating resin. As shown in FIG. 2, concave portions 31 for receiving the pegs 4 are formed at the opposite ends of the second housing 3 when viewed in the X-direction. The concave portion 31 has an attachment groove 32 into which a later-described attachment protrusion 41a of the peg 4 is inserted.

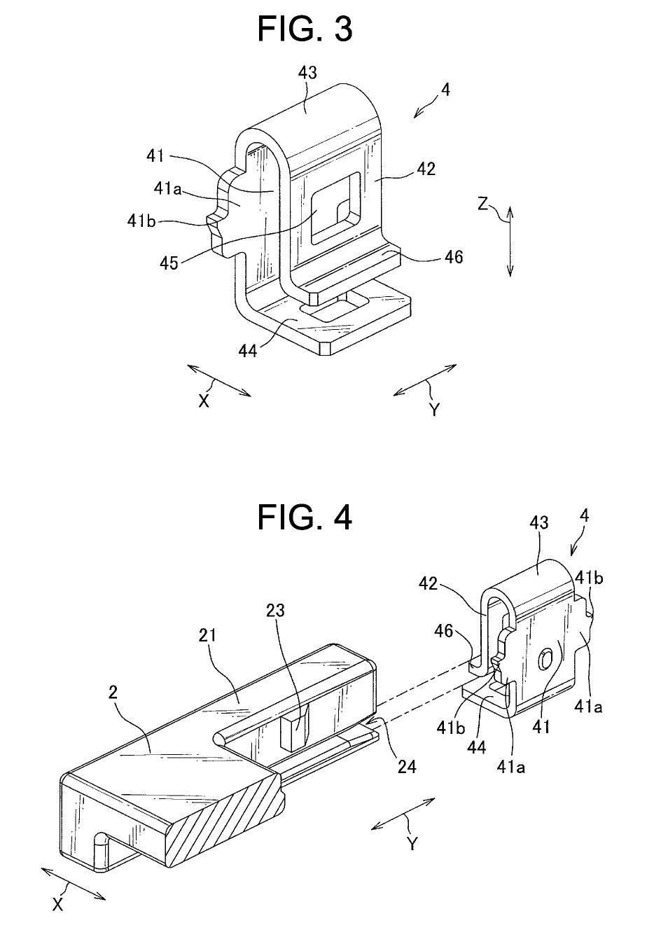

As also shown in FIG. 3, the peg 4 has a first face portion 41 secured to the second housing 3, a second face portion 42 extending in generally parallel to the first face portion 41 and situated outward in the X-direction, an elastically deformable connecting portion 43 that connects an upper end in the Z-direction of the first face portion 41 to an upper end Z-direction of the second face portion 42, and a third face portion 44 that is continuous from a lower portion in the Z-direction of the first face portion 41 and that extends in a direction substantially perpendicular to the first face portion 41. For example, the peg 4 is a one-piece part which is prepared by applying punching and bending processes to a metal plate. The second face portion 42 has an engagement hole 45 formed at its approximate central portion, and also has a guide piece 46 provided at a lower end in the Z-direction of the second face portion and protruding outward in the X-direction. The first face portion 41 has attachment protrusions 41a provided at opposite ends in the Y-direction of the first face portion 41 to attach the peg 4 to the second housing 3. When the first housing 2 is engaged with the second housing 3, the pegs 4 attached to the second housing 3 are positioned inward in the X-direction of the engagement walls 21 of the first housing 2.

When attaching the peg 4 to the second housing 3, the attachment protrusion 41a of the peg 4 is inserted into the attachment groove 32 of the second housing 3, and the peg 4 is moved toward the second housing 3 in the Z-direction. As a latching portion 41b protruding from the attachment protrusion 41a in the Y-direction engages with a recess (not shown) formed at the attachment groove 32, the peg 4 is secured to the second housing 3.

In the following, function of the respective parts during the engagement of the first housing 2 with the second housing 3 is described. Firstly, the connector 1 is in a separated condition in which the first housing 2 and the second housing 3 of the connector 1 are positioned separate from each other, as shown in FIG. 1B. As the first housing 2 is moved toward the second housing 3 in the Y-direction, the first housing 2 is engaged with the second housing 3, and the connector 1 is in the engagement condition, as shown in FIG. 1A. When the housings 2 and 3 are moved toward each other in this manner, the guide piece 46 of the peg 4 is inserted into the guide groove 24 of the first housing 2, and the third face portion 44 extends along a lower side in the Z-direction of the engagement wall 21, as shown in FIG. 4, thereby restricting the relative movement of the housings 2 and 3 in the Y-direction. The guide piece 46 and the guide groove 24 serve as a guide portion, so that the peg 4 guides the relative movement of the first housing 2 and the second housing 3 in the Y-direction.

As the first housing 2 and the second housing 3 are moved toward each other and the latching protrusion 23 of the first housing 2 contact the second face portion 42 of the peg 4, the connecting portion 43 is elastically deformed such that the first face portion 41 and the second face portion 42 approach each other. When the first housing 2 and the second housing 3 are further moved toward each other, the peg 4 is brought into a neutral condition by the restoring force of the connecting portion 43, and the latching protrusion 23 of the first housing engages with the corresponding engagement hole 45 of the peg. In this manner, the engagement hole 45 and the latching protrusion 23 serve as a latching portion, and the pegs 4 latch the first housing 2. Accordingly, the first housing 2 and the second housing 3 are brought into the engaged condition. It should be noted that in the engaged condition, the latching protrusions 23 and the guide pieces 46 are aligned in the Z-direction.

When disengaging the latching protrusion 23 from the engagement hole 45, a jig J is inserted between the second face portion 42 of the peg 4 and the engagement wall 21 from an upper position in the Z-direction, as shown in FIG. 1A. Then, a force directed inward in the X-direction is applied to the second face portion 42, and the connecting portion 43 is elastically deformed such that the second face portion 42 approaches the first face portion 41, thereby the first housing 2 is separated from the second housing 3 in the Y-direction, and the latching protrusion 23 is disengaged from the engagement hole 45. When the first housing 2 and the second housing 3 are moved relative to each other in the Y-direction so as to move away from each other, the guide piece 46 and the guide groove 24 serve as the guide portion, as in the case when the first housing 2 and the second housing 3 move relative to each other toward each other.

The present invention according to this embodiment has the following advantages. That is, the guide grooves 24 formed at the first housing 2 and the guide pieces 46 formed at the pegs 4 serve as the guide portions, thereby facilitating the assembly of the connector and preventing the connection failure between the conductors M of the FPC cable C and the contact 5.

Furthermore, as described above, the guide pieces 46, which function as the guide portions, and engagement holes 45, which function as the latching portions, are provided at the pegs 4. Thus, the increase in the number of components can be prevented.

Furthermore, as described above, the first housing 2 is provided with the guide grooves 24, which function as the guide portions, and the latching protrusions 23, which function as the latching portions. Thus, it is not necessary to design the dimensions of the engagement holes 45 and the guide pieces 46 of the pegs 4 to conform to the dimensions of the FPC cable C, allowing the use of the peg 4 in common for FPC cables having different dimensions. Furthermore, because the first housing 2 is attached to the FPC cable C by the engagement walls 21 provided at the opposite ends in the X-direction and the main body 22 provided at the upper position in the Z-direction, the first housing 2 can be used in common for FPC cables having different dimensions in the Z-direction.

Furthermore, as described above, the engagement walls 21 are situated outward of the pegs 4 in the X-direction, and the engagement walls 21 is provided with the latching protrusions 23 protruding inward in the X-direction. Thus, the latching protrusions 23 and the guide pieces 46 do not protrude outward in the X-direction when the pegs and the latching protrusions are in the engaged condition, preventing an increase in the dimension of the connector 1 in the X-direction.

Furthermore, because the peg 4 is a one-piece part prepared by punching and bending the metal plate, an increase in the number of components can be prevented.

Furthermore, as described above, the engagement hole 45 which is formed at the second face portion 42 of the peg 4 engages with the latching protrusion 23 which protrudes in the X-direction from the engagement wall 21, and the first face portion 41 and the second face portion 42 opposed to each other in the X-direction are connected to each other by the connecting portion 43. Thus, the latching protrusion 23 can be engaged with and disengaged from the engagement hole 45 by the elastically deforming the connecting portion 43 in the above-described manner, allowing the condition of the connector 1 to be easily shifted from the engaged condition to the separated condition.

Furthermore, as described above, the first housing 2 is secured to the second housing 3 by the engagement walls 21 and the pegs 4 provided at the opposite ends in the X-direction. Thus, the housings 2 and 3 are reliably engaged with each other, preventing the unintentional disengagement between the housings 2 and 3 upon application of an external force in any direction.

Furthermore, as described above, the guide pieces 46 protruding in the X-direction are inserted into the guide grooves 24, and the third face portions 44 are extending along the lower side in the Z-direction of the engagement walls 21. Thus, the third face portions 44 reliably prevent the first housing 2 and the second housing 3 from moving relative to each other in the Z-direction.

It should be noted that the present invention is not limited to the above-described embodiment and encompasses other configurations that can achieve the object of the present invention. The present invention encompasses changes and modifications described below. For example, in the above-described embodiment, the engagement holes 45 and the guide pieces 46 are formed at the pegs 4, and the latching protrusions 23 and the guide grooves 24 are formed at the first housing 2. However, the engagement holes may be formed at the first housing and the latching protrusions may be formed at the pegs, and the guide pieces may be formed at the first housing and the guide grooves may be formed at the pegs. Any other suitable configurations are also satisfactory as long as the peg serve as the guide portion and the latching portion.

In the above-described embodiment, the connecting portion 43 of the peg 4 is elastically deformed and the engagement hole 45 is engaged with the latching protrusion 23 formed on the engagement wall 21. However, a latching protrusion which can elastically deform may be provided to one of the peg and the engagement wall, and the latching protrusion may be engaged with an engagement hole formed at the other one of the peg and the engagement wall.

In the above-described embodiment, the peg 4 has the first face portion 41, the second face portion 42 and the connecting portions 43. However, the second face portion 42 and the connecting portion 43 may be eliminated, and the first face portion secured to the second housing 3 may be provided with the engagement hole and the guide piece. Such configuration can simplify the peg and can reduce the cost.

In the above-described embodiment, the peg 4 is a one-piece part that is prepared by punching and bending the metal plat; however, the peg may be made from other suitable materials with other suitable processing as long as the peg can serve as the latching portion and the guide portion. For example, the peg may be made from a resin material and fabricated by injection molding. Alternatively, the first face portion, the second face portion and the connecting portion of the peg may be formed as separate parts.

In the above-described embodiment, the first housing 2 has the engagement walls 21 provided at the opposite ends of the FPC cable C in the X-direction, and also has the main body 22 provided at the upper side in the Z-direction. It should be noted, however, that the first housing may further have a second main body at a lower side in the Z-direction. Such configuration ensures that the first housing is securely attached to the FPC cable C. In addition, with this configuration, by connecting the first main body to the second main body by a connecting wall that can change its dimension in the Z-direction, the first housing can be used in common for FPC cables C having different dimensions in the Z-direction.

In the above-described embodiment, the first housing 2 attached to the FPC cable C has the engagement walls 21, and the second housing 3 is provided with the pegs 4. However, one of the two housings which is attached to the FPC cable C may be provided with the pegs and the other one of the two housings may be provided with the engagement walls. Alternatively, the pegs may be attached on the engagement walls, and the housing which has no engagement walls may be guided and latched by the pegs.

In the above-described embodiment, the first housing 2 is directly attached to the FPC cable C, and the contact 5 is directly inserted into the second housing 3. However, a suitable adapter may be attached to the FPC cable C or the contact 5. With such configuration, the connector 1 can be used in common for FPC cables having different dimensions in the X-direction.

In the above-described embodiment, the connector 1 connects the FPC cable C to another cable or an electrical device. However, the connector may have a different configuration as long as the connector can connect a plurality of conductors M arranged in a flat plate shape to another cable or an electrical device. For example, the first housing may be attached to an FPC board.

It should be noted that the exemplary configurations and methods for carrying out the present invention are described in the foregoing; however, the present invention is not limited to such configuration and method. In other words, although the present invention is illustrated in the drawings and described in connection with particular embodiments, a person skilled in the art may be able to make various changes and modifications to the above-described embodiment with regard to the shape, material, number and other details, without departing from the technical concept and the object of the present invention. Therefore, those descriptions about the shape, material and so on in the foregoing are only examples to facilitate the understanding to the present invention and do not limit the present invention. Thus, the above-described parts, elements and components that have particular names but exclude part or all of such limitations on the shape, material and so on are still encompassed by the present invention.

### REFERENCE SIGNS

1: connector
2: first housing
3: second housing
4: peg (fixture member)
5: contact
23: latching protrusion
24: guide groove
41: first face portion
42: second face portion
43: connecting portion
45: engagement hole
46: guide piece

What is claimed is:

1. A connector comprising:
a first housing; and
a second housing configured to engage with the first housing;
wherein one of the first housing and the second housing is attached to a plurality of conductors arranged in a flat plate shape, and another one of the first housing and the second housing is configured to receive a contact which is to be electrically connected to said plurality of conductors,
wherein fixture members are provided at opposite ends of the second housing in an arrangement direction of said plurality of conductors, said fixture members being configured to secure the first housing to the second housing,
wherein said fixture member includes a latching portion for latching the first housing, and a guide portion for guiding the first housing with respect to the second housing in an engagement direction,
wherein one of the first housing and the fixture member includes a guide groove that opens toward another one of the first housing and the fixture member, and the another one of the first housing and the fixture member includes a guide piece that is arranged to be inserted into the guide groove, and
wherein said guide portion includes the guide groove or the guide piece.

2. The connector according to claim 1, wherein said fixture member is a one-piece member and has a first face portion secured to the second housing, a second face portion provided opposed to the first face portion in said arrangement direction, and an elastically deformable connecting portion connecting the first face portion to the second face portion, and
wherein the latching portion is provided to the second face portions.

3. The connector according to claim 1, wherein the first housing has a pair of engagement walls situated outward of opposite ends of said plurality of conductors in said arrangement direction,
wherein the engagement wall has a latching protrusion that protrudes inward in the arrangement direction, and a guide groove that opens inward in the arrangement direction, and
wherein the fixture members are arranged inward of the engagement walls, and the latching portion includes an engagement hole that opens outward in the arrangement direction and configured to engage with the latching protrusion.

4. The connector according to claim 2, wherein the first housing has a pair of engagement walls situated outward of opposite ends of said plurality of conductors in said arrangement direction,
wherein the engagement wall has a latching protrusion that protrudes inward in the arrangement direction, and a guide groove that opens inward in the arrangement direction, and
wherein the fixture members are arranged inward of the engagement walls, and the latching portion includes an engagement hole that opens outward in the arrangement direction and configured to engage with the latching protrusion.
